(19) United States
(12) Patent Application Publication
(10) Pub. No.: US 2019/0223479 A1
(43) Pub. Date: Jul. 25, 2019

(54) SUGAR-DIPEPTIDE CONJUGATES AS FLAVOR MOLECULES

(71) Applicant: NESTEC S.A., Vevey (CH)

(72) Inventors: Candice Marie SMARRITO-MENOZZI, Belmont-sur-Lausanne (CH); Maria Eugenia BARCOS, Epalinges (CH); Florian VITON, Lausanne 2 (CH); Sonia MANGANIELLO, Neuchatel (CH)

(73) Assignee: Nestec S.A., Vevey (CH)

(21) Appl. No.: 16/318,000

(22) PCT Filed: Jul. 19, 2017
(86) PCT No.: PCT/EP2017/068174

§ 371 Date: Jan. 15, 2019

(30) Foreign Application Priority Data
Jul. 20, 2016 (EP) 16180347.3

(51) Int. Cl. A23L 27/21; A23K 50/40; A23L 27/00; A23L 23/10

(52) U.S. Cl. CPC A23L 27/215; A23L 23/10; A23L 27/88; A23K 50/40

(57) ABSTRACT

The present invention relates to compounds and compositions for use in enhancing umami taste, saltiness and/or flavors of a food product. Particularly, the present invention relates to compounds which are sugar conjugates between a reducing sugar and a L-lysine molecule, and compositions comprising them.

The present invention relates to compounds and compositions for use in enhancing umami taste, saltiness and/or flavors of food products.

Many foods that are consumed today are rich in umami and/or meaty taste and flavor. Umami or meaty taste of a food product can for example be achieved or enhanced by adding separately monosodium glutamate (MSG) and/or the ribonucleotides GMP and IMP into those culinary recipes. Many such taste enhancers are available today and are used for various different culinary applications and in various different forms such as pastes, powders, liquids, compressed cubes or granules.

The addition of culinary additives helps to provide deliciousness and to enhance taste and flavor properties of food products. And indeed, all around the world taste and flavor is perceived as one of the key attributes of a high quality meal. Hence, a lot of research efforts goes into the identification and analysis of new molecules providing deliciousness, and enhanced taste and flavor properties of foods.

Also common kitchen salt, basically sodium chloride, plays an important role in influencing and enhancing the taste and flavor of food products. And salt also by itself is an important taste component. It is established today, that the sensation of taste of a food product is composed of five basic tastes, i.e. sweetness, sourness, saltiness, bitterness and umami. Those different tastes are captured on our tongue by specifically differentiated taste buds. Thereby, bitter and sour foods are usually found rather unpleasant, while sweet, salty and umami tasting food products are generally regarded as providing a pleasurable sensation upon eating such food products.

Although it is well recognized that consumption of a certain amount of salt is indispensable for a healthy human life, the tendency of today's consumption and diets is that too much salt, particularly sodium chloride, is consumed on an individual basis and worldwide. It is recognized today that ingesting excessive quantities of sodium salt raises the risk of hypertension, kidney diseases and heart diseases. Hence, there is still a need in the art to provide new flavorings which allow the reduction of sodium salts in nutritional diets, and which still can provide the taste enhancing effect and saltiness as for example traditional kitchen salt.

T. Sonntag et al. in J. Agric. Food Chem. 2010, 58, 6341-6350, describes sensory guided identification of α-amino acid compounds as contributors to the tick-sour and mouth-drying orosensation of stewed beef juice. Thereby they classify the taste qualities of different amino acids and sugars into bitter tasting, umami-like, salty-tasting and sweet-tasting compounds.

The object of the present invention is to improve the state of the art and to provide an alternative or improved solution to the prior art to overcome at least some of the inconveniences described above. Particularly, the object of the present invention is to provide an alternative or improved solution for enhancing the taste and/or flavour of food products. Particularly, the object of the present invention is to improve the taste, as for example the delicious, umami and/or salty taste, of a food product. The object of the present invention is also to provide a solution for compensating for the lost saltiness when lowering the effective amount of sodium salt in a food product. A further the object of the present invention is to improve the flavour of a food product, as for example the roasted grilled and meaty flavour, as well as the overall flavour intensity and persistence.

The object of the present invention is achieved by the subject matter of the independent claims. The dependent claims further develop the idea of the present invention.

Accordingly, the present invention provides in a first aspect a compound which is a sugar conjugate between a reducing sugar and a L-lysine molecule; or a salt of said compound.

In a second aspect, the invention relates to a composition comprising said compound in an amount of at least 0.25 mg/g, preferably of at least 0.5 mg/g, 1.0 mg/g or 1.5 mg/g, of the total composition.

Further aspects of the present invention relate to a use of said compound for enhancing the flavor and/or taste of a food product.

A still further aspect of the present invention is a method for enhancing the flavor and/or taste of a culinary food product, comprising the step of adding said compound or the composition comprising said compound to a food product.

The inventors surprisingly found that some sugar conjugates of L-lysine have a much stronger taste enhancing effect than their corresponding aglycones. In fact, these sugar conjugates enhance the saltiness and umami taste perception at much lower threshold levels than their corresponding aglycones. They also enhance the persistency of those tastes in the mouth and also reduce overall perceived bitterness of the products. The sugar conjugate molecules are typically generated in-situ during thermal processing of food raw materials by condensation of a reducing sugar with an L-lysine amino acid. The sensory taste characteristics of the corresponding aglycones, i.e. the sugar mono-sachharides and the L-lysine have been identified and described for example by T. Sonntag et al. in J. Agric. Food Chem. 2010, 58, 6341-6350. Thereby, the sugars have been described as sweet-tasting compounds, while L-lysine has been described as a bitter tasting compound.

However, the taste properties of these aglycones differ from the ones of their corresponding sugar conjugates. Evidence thereof is provided in the Example section below. Therefore, the molecules described in the present invention are more potent taste enhancers than the known corresponding aglycones. They allow further reducing the amounts and uses of for example mono-sodium glutamate (MSG), of ribonucleotides such as IMP and GMP, and of regular kitchen salt in culinary food products and applications, without compromising flavor richness, deliciousness and salt perception of said products. They also allow generating savory food concentrates which have much less or no MSG, ribonucleotides and/or salt, and which still provide a strong and typical delicious, umami and salt tasting effect if applied to a food product. It even allows generating such savory food concentrates which are much stronger and more concentrated in providing a salty taste to a food product upon application.

### BRIEF DESCRIPTION OF THE DRAWINGS

FIG. 1: Sensory evaluation of chicken soup spiked with 2 g/L GluAmadori-Lys2 (A) or GluAmadori-Lys1 (B) in comparison to un-spiked reference soup (Ref). Sensory scores of the taste/flavor attributes are shown on a scale from 0 to 8. The attributes are as follows: a) saltiness; b) bitterness; c) sweetness; d) boiled chicken; e) grilled; f) meaty; g) umami; and h) overall flavor persistency.

### DETAILED DESCRIPTION OF THE INVENTION

The present invention pertains to a compound which is a sugar conjugate between a reducing sugar and a L-lysine molecule; or a salt of said compound.

Preferably, the compound of the present invention is selected from the general formula I) or II),

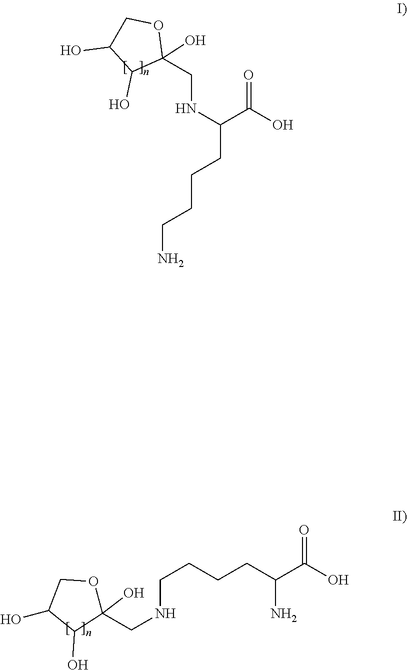

wherein n is equal 1 or 2.

Preferably, the reducing sugar of the present compound is glucose (e.g. when n is equal 2), xylose or ribose (e.g. when n is equal 1).

Therefore, preferred embodiments of the present invention pertain to a compound which can be a sugar conjugate between a glucose molecule with a L-lysine molecule according to either the general formula I) or II), or a sugar conjugate between a xylose molecule with a L-lysine molecule according to either the general formula I) or II), or a sugar conjugate between a ribose molecule with a L-lysine molecule according to either the general formula I) or II).

A second aspect of the invention relates to a composition comprising said compound in an amount of at least 0.25 mg/g, at least 0.50 mg/g, at least 0.75 mg/g, at least 1.0 mg/g, at least 1.5 mg/g, at least 1.7 mg/g, at least 2 mg/g, at least 2.5 mg/g, at least 3 mg/g, at least 3.5 mg/g, or at least 5 mg/g of the total composition.

In one embodiment of the present invention, the composition is in the form of an extract from a plant, fungus and/or meat material. Preferably, the composition is in the form of an extract, for example from plant, fungus and/or meat material, where the compound of the present invention has been enriched. An advantage thereby is that the composition is of natural origin and does not contain any chemically synthesized compounds.

In another embodiment, the composition of the present invention is the result of a flavor reaction. The term “flavor reaction” refers herein to a chemical reaction occurring between at least one reducing sugar and at least one amino acid. Typically, this chemical reaction occurs during a heating process and is typically also referred to as Maillard reaction. In one example, the flavor reaction is a Maillard reaction.

In a preferred embodiment, the composition of the present invention is food grade. Under “food grade” the inventors mean that the composition is suitable for human consumption, for example directly, in concentrated form, and/or when used diluted in a food product.

Preferably, the composition of the present invention is a food product.

For example, the composition of the present invention is selected from the group consisting of a culinary seasoning product, a cooking aid, a sauce or soup concentrate, a dry or wet pet-food product.

Further aspects of the present invention relate to a use of said compound for enhancing the flavor and/or taste of a food product. Such a food product may be a ready-to-eat food product. It may also be a flavor concentrate used for seasoning a still further other food product. Advantageously, the compound of the present invention may be used for being added to a seasoning, a cooking aid or a food concentrate product. Thereby the strength of providing e.g. an umami or a salty taste to a still further food product is improved in such a seasoning, cooking aid or food concentrate product.

Particularly, the present invention relates to the use of the compounds for enhancing the umami and/or salt taste of a food product. More particularly, the invention relates to the use of the compounds of the present invention for enhancing the saltiness of a food product. Particularly, this use would allow to either increase the perceived saltiness of a food product without actually increasing the salt or sodium level of said food product, or to decrease the amount of salt or sodium used in a food product with maintaining the actual perceived saltiness of said product. Advantageously thereby the amount of salt and sodium consumed by consumers with such a product today could be significantly reduced.

Furthermore, the present invention also relates to a use of said compound for enhancing the flavor, such as the meaty and/or roasted grilled flavor of a food product. Such a food product may be a ready-to-eat food product. It may also be a flavor concentrate used for seasoning a still further other food product. Advantageously, the compound of the present invention may be used for being added to a seasoning, a cooking aid or a food concentrate product. Thereby the strength of providing a meaty and/or roasted flavor to a still further food product is improved in such a seasoning, cooking aid or food concentrate product.

Further aspects of the present invention also relate to a use of a composition comprising said compound in an amount of at least 0.25 mg/g, at least 0.50 mg/g, at least 0.75 mg/g, at least 1.0 mg/g, at least 1.5 mg/g, at least 1.7 mg/g, at least 2 mg/g, at least 2.5 mg/g, at least 3 mg/g, at least 3.5 mg/g, or at least 5 mg/g of the total composition, for enhancing the taste and/or flavor of a food product. Advantageously, such a food product may be a ready-to-eat food product.

A still further aspect of the present invention is a method for enhancing the umami taste and/or saltiness of a culinary food product, comprising the step of adding said compound or the composition comprising said compound to a food product. The food product can be a ready-to-eat food product or a flavor concentrate.

A still further aspect of the present invention is a method for enhancing the meaty and/or roasty flavor of a culinary food product, comprising the step of adding said compound or the composition comprising said compound to a food product.

One still further embodiment of the present invention is a method for reducing the amount of sodium chloride in a food product without reducing the perceived saltiness of said food product.

Those skilled in the art will understand that they can freely combine all features of the present invention disclosed herein. In particular, features described for the products of the present invention may be combined with the uses and method of the present invention, and vice versa. Further, features described for different embodiments of the present invention may be combined. Further advantages and features of the present invention are apparent from the figures and examples.

### Example 1: Synthesis of GluAmadori-Lys1 (General Formula I)

### Step-1: Synthesis of N₆-(((9H-fluoren-9-yl)methoxy)carbonyl)-N2-((2,3,4,5-tetrahydroxytetrahydro-2H-pyran-2-yl)methyl)-lysine

D-Glucose (16.43 g, 91.304 mmol, 2.8 eq.) and sodium bisulfite (0.94 g, 9.130 mmol, 0.28 eq.) were suspended in a mixture of methanol (60 mL) and glycerol (30 mL). The reaction mixture was refluxed for 30 min at 80° C. and then H-Lys(Fmoc)-OH (12.0 g, 32.608 mmol, 1.0 eq., Combi blocks) and acetic acid (8 mL) were added. The reaction mass was heated at 80° C. for 3 hours. After completion, the reaction mass was cooled down and diluted with water (60 mL). The diluted reaction mixture was then poured in packed column with Amberlite IRN-77 ion exchange resin (120 g). The crude was eluted in water and the collected water fractions were evaporated under reduced pressure to obtain 13 g pure N₆-(((9H-fluoren-9-yl)methoxy) carbonyl)-N₂-((2,3,4,5-tetrahydroxytetrahydro-2H-pyran-2-yl)methyl)-lysine (75.23%).

### Step-2: Synthesis of GluAmadori-Lys1

N₆-(((9H-fluoren-9-yl)-methoxy)carbonyl)-N₂-((2,3,4,5-tetrahydroxytetrahydro-2H-pyran-2-yl)methyl)-lysine (13.0 g, 24.528 mmol, 1.0 eq.) was dissolved in MeOH (500 mL) and 10% Pd on Carbon (50% moisture) was slowly added. The reaction mass was stirred at room temperature overnight under H₂ atmosphere. After completion, the reaction mass was filtered through Celite and the resulting cake was washed with methanol and water. The filtrate was concentrated under reduced pressure to give a syrup which was then poured into packed column of Amberlite IRN-77 ion exchange resin (100 g). The crude was eluted in 0.5% NH₃ in water and the collected water fractions were evaporated under reduced pressure to obtain 5.0 g GluAmadori-Lys-1 (66.66%).

1H NMR spectra were recorded on a Bruker 400 in D₂O: 1.307-1.407 (m, 2H), 1.557-1.650 (m, 2H), 1.776-1.849 (m, 2H), 2.872-2.910 (t, 1H), 3.141-3.226 (m, 2H), 3.607-3.673 (m, 3H), 3.886-3.994 (m, 1H).

LC-MS was carried out using X-Bridge C18 (250×4.6 mm) 5 micron. The column flow was 0.3 mL/min and the solvent was 0.2% TFA in water (isocratic conditions). The table below summarizes molecular ion and retention time (RT) for D-Glucose, L-lysine and GluAmadori-Lys1 respectively.

| | | |
|---|---|---|
| Starting | Molecular | |
| material | ion peak | Wavelength and RT |

| | | | |
|---|---|---|---|
| D-Glucose | 180.06 | 254 nm | 5.939 |
| L-Lysine | 147.20 | 254 nm | 10.711 |
| GluAmadori- | 309.25 | 254 nm | 11.226 |
| Lys1 | | | |

### Example 2: Synthesis of GluAmadori-Lys2 (general formula II)

### Step-1: Synthesis of N₂-(((9H-fluoren-9-yl)methoxy)carbonyl)-N₆-((2,3,4,5-tetrahydroxytetrahydro-2H-pyran-2-yl)methyl)lysine

D-Glucose (20.52 g, 114.006 mmol, 2.8 eq.) and sodium bisulfite (1.18 g, 11.400 mmol, 0.28 eq.) were suspended in a mixture of methanol (150 mL) and glycerol (17.5 mL). The reaction mixture was refluxed for 30 min at 80° C. followed by the addition of Fmoc-Lys-OH (15.0 g, 40.716 mmol, 1.0 eq., Combo blocks) and acetic acid (25.7 mL). The reaction mass was heated for 3 hours at 80° C., cooled down and diluted with water (150 mL). The mixture was then poured into column packed with Amberlite IRN-77 ion exchange resin (150 g). The crude was eluted in water and the collected water fractions were evaporated under reduced pressure to obtain 20.0 g desired compound (92.72%).

### Step-2: Synthesis of GluAmadori-Lys2

N₂-(((9H-fluoren-9-yl)methoxy) carbonyl)-N₆-((2,3,4,5-tetrahydroxytetrahydro-2H-pyran-2-yl)methyl)-lysine (20.0 g, 37.735 mmol, 1.0 eq.) was dissolved in MeOH (400 mL) and 10% Pd on Carbon (50% moisture) was slowly added and the resulting mixture was stirred overnight at room temperature under H₂ atmosphere. The reaction mass was then filtered through Celite, washed with water and concentrated under reduced pressure. The syrup was poured in Amberlite IRN-77 ion exchange resin (100 g), eluted with 0.5% NH₃ in water and the collected water fractions were evaporated under reduced pressure to obtain 5.2 g pure compound GluAmadori-Lys2 (44.75%).

1H NMR spectra were recorded on a Bruker 400 in D₂O: 1.274-1.401 (m, 2H), 1.601-1.676 (m, 2H), 1.753-1.814 (m, 2H), 3.000-3.040 (m, 2H), 3.158-3.432 (m, 2H) 3.551-3.591 (m, 4H), 3.616-3.642 (m, 1H), 3.702-3.727 (m, 1H).

LC-MS was carried out using X-Bridge C18 (250×4.6 mm) 5 micron. The column flow was 0.3 mL/min and solvents used were 20 mM ammonium acetate and 0.1% TFA in water. The table below summarizes molecular ion and retention time (RT) for D-Glucose, L-lysine and GluAmadori-Lys2 respectively.

| | | |
|---|---|---|
| Starting | Molecular | |
| material | ion peak | Wavelength and RT |

| | | | |
|---|---|---|---|
| D-Glucose | 180.06 | 254 nm | 5.939 |
| L-Lysine | 147.15 | 254 nm | 6.525 |
| GluAmadori- | 309.20 | 254 nm | 7.876 |
| Lys2 | | | |

### Example 3: Synthesis of XyAmadori-Lys1 (General Formula I)

### Step-1: Synthesis of N6-((benzyloxy)carbonyl)-N2-((2,3,4-trihydroxytetrahydrofuran-2-yl)methyl)lysine

D-Xylose (32.14 g, 214.285 mmol, 4.0 eq.) was suspended in Methanol (800 mL). The reaction mixture was refluxed for 60 min at 90° C. followed by the addition of H-Lys(z)-OH (15.0 g, 53.571 mmol, 1.0 eq.) and ACOH (2.0 mL). The reaction mass was heated at 90° C. for further 4 hours. After completion, the reaction mass was freeze-dried to give a final crude compound which was purified by precipitation in MeOH:ACN (1:5). The solid product was freeze-dried to give 14.0 g of pure compound N6-((benzyloxy) carbonyl)-N2-((2,3,4-trihydroxytetrahydrofuran-2-yl)methyl)lysine. (Yield: 63.6%)

### Step-2: Synthesis of ((2,3,4-trihydroxytetrahydrofuran-2-yl)methyl)lysine (XylAmadori-Lys1)

N6-((benzyloxy)carbonyl)-N2-((2,3,4-trihydroxytetrahydrofuran-2-yl)methyl)lysine (10.0 g, 24.271 mmol, 1.0 eq.) was dissolved in MeOH (800 mL) and 10% Pd on Carbon (50% moisture) was slowly added. The reaction mixture was stirred under H₂ atmosphere at room temperature for 2 hours. After completion the reaction mass was filtered through Celite and washed with water. It was freeze-dried to give 5.0 g of pure compound XylAmadori-Lys1. (Yield-74.18%).

1H NMR spectra were recorded on a Bruker 400 in D₂O: 1.333-1.406 (m, 2H), 1.565-1.623 (m, 2H), 1.787-1.855 (m, 2H), 2.880-2.917 (m, 2H), 3.147-3.248 (m, 1H), 3.544-3.673 (m, 2H), 3.844-3.888 (m, 1H), 4.060-4.193 (m, 1H), 4.200-4.369 (m, 2H).

LC-MS was carried out using X-Bridge C18 (250×4.6 mm) 5 μm. The column flow was 0.3 mL/min and solvents used was 10 mM ammonium acetate (isocratic conditions). The table below summarizes molecular ion and retention time (RT) for D-Xylose, L-lysine and XylAmadori-Lys1 respectively.

| | | |
|---|---|---|
| Starting | Molecular | |
| material | ion peak | Wavelength and RT |

| | | | |
|---|---|---|---|
| D-Xylose | 150.0 | 202 nm | 9.322 |
| L-Lysine | 147.2 | 202 nm | 8.572 |
| XylAmadori- | 279.20 | 202 nm | 9.046 |
| Lys1 | | | |

### Example 4: Synthesis of XylAmadori-Lys2 (General Formula II)

### Step-1: Synthesis of N2-((benzyloxy)carbonyl)-N6-((2,3,4-trihydroxytetrahydrofuran-2-yl)methyl)lysine

D-Xylose (21.42 g, 142.857 mmol, 4.0 eq.) was suspended in Methanol (800 mL). The reaction mixture was refluxed for 60 min at 90° C. followed by the addition of Cbz-Lys-OH (10.0 g, 35.714 mmol, 1.0 eq.) and ACOH (2.0 mL). The reaction mass was heated at 90° C. for further 4 hours. After completion, the reaction mass was freeze-dried to give a final crude compound which was purified by precipitation in MeOH:ACN (1:5). The solid product was freeze-dried to give 10.0 g of pure compound N2-((benzyloxy)carbonyl)-N6-((2,3,4-trihydroxytetrahydrofuran-2-yl)methyl)lysine. (Yield:71.42%)

### Step-2: Synthesis of N6-((2,3,4-trihydroxytetrahydrofuran-2-yl)methyl)lysine (XylAmadori-Lys2)

N2-((benzyloxy)carbonyl)-N6-((2,3,4-trihydroxytetrahydrofuran-2-yl)methyl)lysine (10.0 g, 24.271 mmol, 1.0 eq.) was dissolved in MeOH (800 mL) and 10% Pd on Carbon (50% moisture) was slowly added. The reaction mixture was stirred at room temperature for 2 hours under H₂ atmosphere. After completion, the reaction mass was filtered through Celite and washed with water. It was freeze-dried to give 4.8 g of pure compound XylAmadori-Lys-2. (Yield-71.61%).

1H NMR spectra were recorded on a Bruker 400 in D₂O: 1.349-1.402 (m, 2H), 1.675-1.694 (d, 2H), 1.778-1.812 (m, 2H), 3.025-3.063 (m, 2H), 3.200-3.322 (m, 1H), 3.532-3.669 (m, 2H), 3.800-3.869 (m, 1H), 3.982-4.096 (m, 1H), 4.109-4.191 (m, 1H), 4.220-4.313 (m, 1H).

LC-MS was carried out using X-Bridge C18 (250×4.6 mm) 5 μm. The column flow was 0.3 mL/min and solvents used was 10 mM ammonium acetate (isocratic conditions). The table below summarizes molecular ion and retention time (RT) for D-Xylose, L-lysine and XylAmadori-Lys2 respectively.

| | | |
|---|---|---|
| Starting | Molecular | |
| material | ion peak | Wavelength and RT |

| | | | |
|---|---|---|---|
| D-Xylose | 150.0 | 202 nm | 9.059 |
| L-Lysine | 147.2 | 202 nm | 8.463 |
| XylAmadori- | 279.20 | 202 nm | 8.931 |
| Lys2 | | | |

### Example 5: Synthesis of RibAmadori-Lys1 (General Formula I)

### Step-1: Synthesis of N6-((benzyloxy)carbonyl)-N2-((2,3,4-trihydroxytetrahydrofuran-2-yl)methyl)lysine

D-Ribose (32.14 g, 214.285 mmol, 4.0 eq.) was suspended in Methanol (800 mL). The reaction mixture was refluxed for 60 min at 90° C. followed by the addition of H-Lys(z)-OH (15.0 g, 53.571 mmol, 1.0 eq.) and ACOH (2.0 mL). The reaction mass was heated at 90° C. for further 4 hours. After completion, the reaction mass was freeze-dried to give a final crude compound which was purified by precipitation in MeOH:ACN (1:5). The solid product was freeze-dried to give 12.0 g of pure compound N6-((benzyloxy)carbonyl)-N2-((2,3,4-trihydroxytetrahydrofuran-2-yl)methyl)lysine. (Yield: 54.54%).

### Step-2: Synthesis of ((2,3,4-trihydroxytetrahydrofuran-2-yl)methyl)lysine (RibAmadori-Lys1)

N6-((benzyloxy)carbonyl)-N2-((2,3,4-trihydroxytetrahydrofuran-2-yl)methyl)lysine(10.0 g, 29.126 mmol, 1.0 eq.) was dissolved in MeOH (800 mL) and 10% Pd on Carbon (50% moisture) was slowly added. The reaction mixture was stirred at room temperature for 2 hours under H₂ atmosphere. After completion, the reaction mass was filtered through Celite and washed with water. It was freeze-dried to give 5.0 g of pure compound RibAmadori-Lys1. (Yield-61.57%).

1H NMR spectra were recorded on a Bruker 400 in D₂O: 1.348-1.404 (m, 2H), 1.427-1.676 (m, 2H), 1.837-1.901 (m, 2H), 2.912-2.949 (t, 2H), 3.145-3.276 (m, 2H), 3.571-3.697 (m, 2H), 3.712-3.742 (m, 1H), 3.819-3.874 (m, 1H), 4.008-4.012 (m, 1H), 4.221-4.398 (m, 1H).

LC-MS was carried out using X-Bridge C18 (250×4.6 mm) 5 μm. The column flow was 0.3 mL/min and solvents used was 10 mM ammonium acetate (isocratic conditions). The table below summarizes molecular ion and retention time (RT) for D-Ribose, L-lysine and RibAmadori-Lys1 respectively.

| | | |
|---|---|---|
| Starting | Molecular | |
| material | ion peak | Wavelength and RT |

| | | | |
|---|---|---|---|
| D-Xylose | 150.0 | 202 nm | 9.438 |
| L-Lysine | 147.2 | 202 nm | 8.478 |
| RibAmadori- | 279.20 | 202 nm | 9.007 |
| Lys1 | | | |

### Example 6: Synthesis of RibAmadori-Lys2 (General Formula II)

### Step-1: Synthesis of N2-((benzyloxy)carbonyl)-N6-((2,3,4-trihydroxytetrahydrofuran-2-yl)methyl)lysine

D-Ribose (21.42 g, 142.857 mmol, 4.0 eq.) was suspended in Methanol (800 mL). The reaction mixture was refluxed for 60 min at 90° C. followed by the addition of Cbz-Lys-OH (10.0 g, 35.714 mmol, 1.0 eq.) and ACOH (2.0 mL). The reaction mass was heated at 90° C. for further 4 hours. After completion, the reaction mass was freeze-dried to give a final crude compound which was purified by precipitation in MeOH:ACN (1:5). The solid product was freeze-dried to give 11.0 g of pure compound N2-((benzyloxy)carbonyl)-N6-((2,3,4-trihydroxytetrahydrofuran-2-yl)methyl)lysine. (Yield: 74.77%).

### Step-2: Synthesis of N6-((2,3,4-trihydroxytetrahydrofuran-2-yl)methyl)lysine (RibAmadori-Lys2)

N2-((benzyloxy) carbonyl)-N6-((2,3,4 trihydroxytetrahydrofuran-2-yl)methyl)lysine (10.0 g, 24.271 mmol, 1.0 eq.) was dissolved in MeOH (800 mL) and 10% Pd on Carbon (50% moisture) was slowly added. The reaction mixture was stirred at room temperature for 2 hours under H2 atmosphere. After completion, the reaction mass was filtered through Celite and washed with water. It was freeze-dried to give a final 5.05 g of pure compound RibAmadori-Lys2. (Yield-75.00%).

1H NMR spectra were recorded on a Bruker 400 in D₂O: 1.392-1.466 (m, 2H), 1.640-1.714 (m, 2H), 1.790-1.896 (m, 2H), 2.979-3.089 (m, 2H), 3.121-3.262 (m, 1H), 3.527-3.601 (m, 1H), 3.708-3.990 (m, 3H), 4.053-4.377 (m, 2H).

LC-MS was carried out using X-Bridge C18 (250×4.6 mm) 5 μm. The column flow was 0.3 mL/min and the solvent used was 10 mM ammonium acetate (isocratic conditions). The table below summarizes molecular ion and retention time (RT) for D-Ribose, L-lysine and RibAmadori-Lys1 respectively.

| | | |
|---|---|---|
| Starting | Molecular | |
| material | ion peak | Wavelength and RT |

| | | | |
|---|---|---|---|
| D-Ribose | 150.0 | 202 nm | 9.350 |
| L-Lysine | 147.2 | 202 nm | 8.324 |
| RibAmadori- | 279.20 | 202 nm | 8.749 |
| Lys2 | | | |

### Example 7: Sensory Data

### Evaluation of GluAmadori-Lys1, GluAmadori-Lys2, XylAmadori-Lys 1, XylAmadori-Lys2, RibAmadori-Lys1 and Rib-Amadori-Lys2 in a Chicken Soup Base

Sample preparation: Chicken soups were prepared by dissolving 6 g chicken base powder (detailed recipe shown in Table 1), 1 g monosodium glutamate and 1 g of sodium chloride in 500 mL hot water. The compounds were separately added at 2 g/l and 0.25 g/l.

TABLE 1
Composition of chicken base powder

| Ingredient | Quantity (%) |
|---|---|
| Chicken Meat powder | 30 |
| Starch | 1.52 |
| Flavors | 2.58 |
| Celery powder | 0.50 |
| Garlic powder | 0.90 |
| Chicken fat | 8.00 |
| Maltodextrine | 56.50 |
| Total | 100 |

Sensory protocol: The sensory evaluation was carried out by 12 panelists, previously screened for their sensory abilities. The panelists assessed a maximum of 6 samples per session. They had Vittel water and crackers as mouth cleansers. In all the cases, the panelists were instructed to evaluate the samples on the following attributes: overall flavor persistency, umami, meaty, grilled/popcorn, boiled chicken, sweet, bitter, salty. The samples were coded with random 3-digit numbers according to a balanced presentation design, heated at approximately 65° C. and then presented in 40 ml brown plastic containers and under red light to minimize appearance bias (the serving was approximately 25 ml per sample).

Sensory Profile of Chicken Soups with GluAmadori-Lys1 and GluAmadori-Lys2:

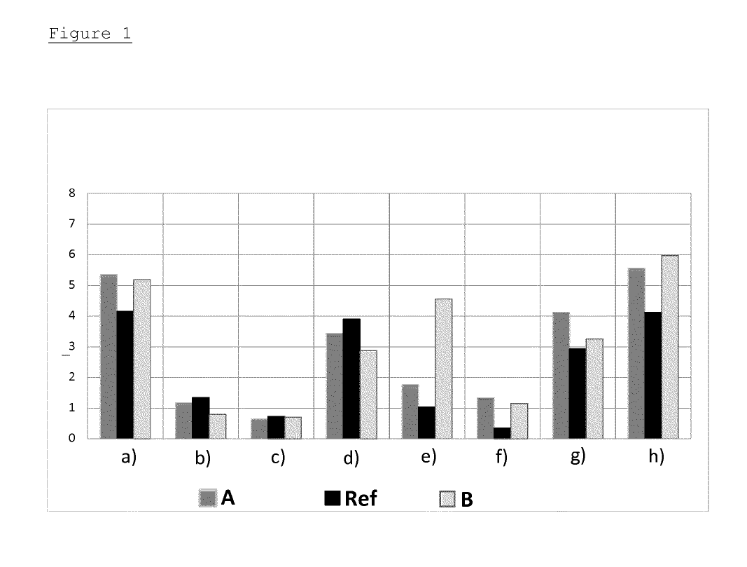

As shown in the FIG. 1, when GluAmadori-Lys1 was added to the chicken soup (Reference soup), grilled, overall flavor persistency and saltiness were significantly increased while the addition of GluAmadori-Lys2 enhanced saltiness, umaminess and overall flavor persistency.

Sensory Profile of Chicken Soups with XylAmadori-Lys1 and XylAmadori-Lys2:

When XylAmadori-Lys1 was added to the chicken soup (Reference soup) at 0.25 g/l and 2 g/l, baked and roasted flavors were significantly increased while the addition of XylAmadori-Lys2 at 2 g/l enhanced meat flavor.

Sensory Profile of Chicken Soups with RibAmadori-Lys1 and RibAmadori-Lys2:

When RibAmadori-Lys1 was added to the chicken soup (Reference soup) at 2 g/l, baked and roasted flavors were significantly increased while the addition of RibAmadori-Lys2 at 2 g/l enhanced roasted flavor.

### Summary of the Sensory Results:

Table 2 summarizes the key sensory effects of the tested sugar conjugates.

TABLE 2

| | | Flavor property in |
|---|---|---|
| | Flavor property in chicken | chicken |
| Compounds | soup (2 g/l) | soup (0.25 g/l) |
| GluAmadori-Lys1 | grilled, saltiness overall | |
| | flavor persistency | |
| GluAmadori-Lys2 | saltiness, umaminess, | |
| | overall flavor persistency. | |
| XylAmadori-Lys1 | baked, roasted flavor | baked, roasted |
| | | flavor |
| XylAmadori-Lys2 | Meat flavor | |
| RibAmadori-Lys1 | baked, roasted flavor | |
| RibAmadori-Lys2 | roasted | |

### Example 8: Comparison Between a Soup Base Comprising the Sugar Conjugate 1-Deoxy-D-Fructosyl-N-Lysine (GluAmadori-Lys2) and a Mixture of Equal Corresponding Amounts of Glucose and Lysine

A first soup was prepared by adding 2 g/L (6.49 mmol/L) 1-deoxy-D-fructosyl-N-Lysine (GluAmadori-Lys2) in the soup base as described above. A second soup was prepared by adding same corresponding molar concentrations of glucose and lysine. The solutions were then evaluated by 6 panelists following the same procedure than described above with using nose-clips.

Obvious differences were found between the two samples: the soup containing the 1-deoxy-D-fructosyl-N-lysine was found more salty and umami.

| Ingredients in chicken bouillon | | Sensory differences |
|---|---|---|
| GluAmadori-Lys2 | Lysine + | Soup containing GluAmadori-Lys2 |
| | Glucose | was perceived as more salty and |
| | | umami |

### Example 9: Seasoning Compositions

Tomato soups can be prepared by dissolving 6 g tomato base powder as can be obtained in the commerce in 500 mL hot water. GluAmadori-Lys1 or GluAmadori-Lys2 can then be added at a concentration of 0.5 g/L or 2.5 g/L to the soups in order to improve their taste and flavor profile. The soups will then have a more pronounced umami taste as well as being perceived as more salty than the corresponding reference soups without the addition of those compounds. For example, a similar tomato soup can now be prepared which has the same saltiness as the reference tomato soup but comprising less sodium chloride.

1. Compound which is a sugar conjugate between a reducing sugar and an L-lysine molecule or a salt of the compound.

2. The compound according to claim 1, where the compound is selected from the general formula I) or II), 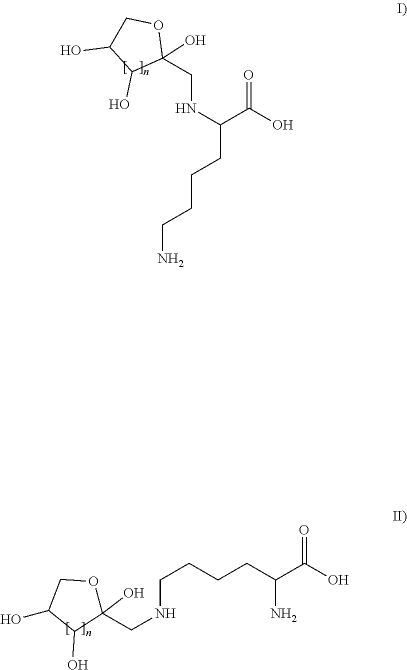
wherein n is equal 1 or 2.

3. The compound according to claim 1, wherein the reducing sugar is selected from the group consisting of glucose, xylose and ribose.

4. A composition comprising a compound of a sugar conjugate between a reducing sugar and a L-lysine molecule or a salt of the compound in an amount of at least 0.25 mg/g.

5. The composition according to claim 4, wherein the composition is a food product.

6. The composition according to claim 4, wherein the composition is selected from the group consisting of a culinary seasoning product, a cooking aid, a sauce or soup concentrate, a dry and a wet pet-food product.

7-10. (canceled)

11. Method for enhancing flavor and/or taste of a culinary food product, comprising the step of adding a sugar conjugate between a reducing sugar and a L-lysine molecule or a salt of the compound to a food product.

12. The method according to claim 11, for reducing the amount of sodium chloride in a food product without reducing saltiness of said food product.
